(19) United States
(12) Patent Application Publication
(10) Pub. No.: US 2004/0244193 A1
(43) Pub. Date: Dec. 9, 2004

(54) Method of making contact with conductive fibers

(75) Inventors: Stefan Jung, Munich (DE); Christl Lauterbach, Hohenkirchen-Siegertsbrunn (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/861,315

(22) Filed: Jun. 4, 2004

(30) Foreign Application Priority Data
Jun. 6, 2003 (DE) 103 25 883.3

(51) Int. Cl. H01R 4/24

(52) U.S. Cl. 29/854; 439/495; 29/835

(57) ABSTRACT

Apparatus and method for electrically connecting an electric conductor to an electronic component including the steps of providing a textile material, in which at least, one flexible, wire-like and/or thread-like electric conductor is arranged, severing the electric conductor at a point to be connected, arranging a contact-making device of the component on at least one surface side of the textile material at the point on the conductor to be connected, and connecting the conductor electrically to the contact-making device.

### CROSS-REFERENCE TO RELATED APPLICATION

This application claims priority to German Patent Application No. 103 25 883.3 filed Jun. 6, 2003, which is incorporated herein by reference in its entirety.

### FIELD OF THE INVENTION

The invention relates to a method for the electrical connection of an electric conductor to an electronic component.

### BACKGROUND OF THE INVENTION

To an increasing extent, the desire is being expressed for clothing and accessories which, in addition to their traditional functions, such as heat, protection and status symbol, can also fulfill additional functions such as healthcare, personal security, communications, etc. Many conceivable applications for intelligent clothing (smart clothes) can be implemented by means of the integration of electronic components and modules in the textiles. Electrical connections between electronic modules distributed in the clothing can be implemented, for example, with conductive wires woven into textile fabrics. As a rule, these electrically conductive fibers are provided with an insulating covering in order to prevent short-circuits as a result of contact between the conductive fibers or as a result of moisture, to which the closing is exposed during wearing. If such conductive fibers are to be connected to electronic modules, the insulation has to be removed at the contact points and electrical contact has to be made.

Hitherto, the insulating covering has been removed by a laser treatment at the points with which contact is to be made. The disadvantages here are that laser treatment at the contact points is expensive and clamping the textile webs is possible only to the extent that the latter are relatively narrow and, if possible, can run in a roll to roll process. Large-area fabrics can be laser treated only with extremely large and complicated apparatus. A further problem is the reproducibility of good contact resistances. Cold soldered points are produced, which can lead to failures.

### SUMMARY OF THE INVENTION

It is thus an object of the invention to propose a simple and economical method for the electrical connection of a conductor to an electronic component. It is also an object of the invention to specify a corresponding apparatus.

According to the invention, a method for the electrical connection of an electric conductor to an electronic component comprises the following steps:

providing a textile material, in which at least one flexible, wire-like and/or thread-like electric conductor is arranged;

severing the electric conductor at the point to be connected;

arranging a contact-making device of the component on at least one surface side of the textile material at the point on the conductor to be connected;

connecting the conductor electrically to the contact-making device.

The electronic component can be, for example, an integrated circuit (chip) or a conductor track which is applied to an insulator and which is connected to an external electronic component.

The textile material is preferably a fabric. In this case, a fabric is understood to mean a two-dimensional textile structure comprising two thread systems in particular crossing at right angles which, as usual, are designated warp and weft. The warp lies in the longitudinal direction of the weaving process, while the weft direction runs transversely with respect to the weaving direction.

The conductor preferably comprises at least one weft and/or warp thread of the fabric.

The severing of the electric conductor at the point to be connected can be carried out in the sense of this invention both in a middle region of the textile material and/or of the electric conductor and in a side or end region of the textile material and/or the electric conductor. If the electric conductor is severed in the middle region, then the two opposite cut ends of the electric conductor are preferably connected electrically to the contact-making device. In the case in which the conductor is severed in an end region, only the cut end of the conductor, that is to say the open end of the conductor, is connected electrically to the contact-making device.

The method further preferably comprises a step of applying the contact-making means to the contact-making device and/or the severed point of the conductor.

The step of applying a contact-making means to the contact-making device can preferably be carried out in production terms at a different point than the actual electrical connection. For example, contact-making devices provided with the contact-making means can be prefabricated. Such contact-making devices can then be processed further in the method according to the present invention.

In a preferred embodiment, the contact-making means is a soldering means, preferably tin solder. The electrical connection step further preferably comprises a step of heating the soldering means for the purpose of electrical connection to the conductor.

As a result of heating the soldering means, the soldering means runs from the point with which contact is to be made into the textile fabric and covers the end face or end faces of the severed conductor. As a result, the electrical contact between the conductor and the contact-making device is produced.

Alternatively, the contact-making means can be a conductive adhesive, preferably silver-filled epoxy resin.

During the electrical connection step, in this case the conductive adhesive flows into the textile fabric in a similar manner to the heated soldering means and covers the end face or faces of the severed conductor and in this way produces an electrical connection between the electric conductor and the contact-making device.

In a further alternative, the electrical connection step can comprise a step of welding the conductor to the contact-making device.

The method further preferably comprises a step of connecting the contact-making device electrically to the electronic component.

The step of connecting the contact-making device electrically to the electronic component is preferably carried out after the step of connecting the conductor electrically to the contact-making device. Alternatively, however, this step can also be carried out before arranging the contact-making device on at least one surface side of the textile material at the point of the conductor to be connected.

The contact-making device can further preferably be designed as part of the electronic component.

In a preferred embodiment, in each case a contact-making device is arranged on both surface sides of the textile material.

In this way, it is possible to achieve the situation where, at the point to be connected, the contact-making means can penetrate into the textile fabric and the severed conductor from both surface sides of the textile fabric, in particular can penetrate the ends, and thus a better electrical connection is formed. At the same time, the mechanical connection can also be improved.

The conductor preferably comprises at least one electrically conductive wire which is sheathed with an insulation, and the step of severing the electric conductor preferably comprises severing the insulation and the wire.

Surprisingly, it has been established that, in order to make electrical contact between the conductor and the contact-making device, it is sufficient to expose the electrically conductive wire of the conductor only by means of a single cut through the conductor. An adequate connection can be produced by means of the electrical connection of the end face or end faces of the severed electrically conductive wire to the contact-making device.

The electrically conductive wire is preferably formed of a material with a low electrical resistance, for example metal such as Cu, Ag, Au, steel, etc. or an electrically conductive plastic, such as a polymer, or carbon fibers. The insulation or the insulating covering is preferably made of plastic, such as polyester, polyamide/polyimide, polyurethane, etc. the insulation is provided in particular to prevent short-circuits as a result of contact with the conductive wires or fibers or as a result of moisture, to which the clothing is exposed during wearing, such as rain, perspiration, etc. The severing step is preferably a mechanical cut, such as one using scissors or a knife or another cutting tool, the electric conductor preferably being entirely severed.

According to the invention, an apparatus is also provided, comprising

a textile material, in which at least one flexible, wire-like and/or thread-like electric conductor is arranged;

at least one contact-making device of an electronic component, which is connected electrically to the conductor;

the conductor being severed at the connecting point to the contact-making device.

The contact-making device and the conductor are preferably connected electrically by means of a contact-making means.

The contact-making means is preferably a soldering means.

Alternatively, the contact-making means can be a conductive adhesive.

In a preferred embodiment, the contact-making device and the conductor are welded to each other.

The contact-making device is preferably designed as part of the component.

The contact-making device is preferably a small metal plate.

The small metal plate can consist of silver or copper, for example typical surface dimensions of such a small metal plate preferably correspond to the typical number of conductive yarns or fibers or wires running parallel to one another, which form a conductor, multiplied by the typical yarn diameter plus an adjustment allowance on account of adjustment inaccuracies.

The electronic component is preferably a flexible lead.

The textile material is preferably a fabric and the conductor comprises at least one weft and/or warp thread of the fabric.

The conductor preferably comprises an electrically conductive wire which is sheathed with an insulation.

A conductor can thus preferably be formed from a plurality of individual conductive wires or fibers, which are in each case sheathed with an insulation and are incorporated in the textile material.

### BRIEF DESCRIPTION OF THE DRAWINGS

Further objects, features and advantages of the present invention become obvious from the following description of preferred embodiments of the present invention with reference to the drawings, in which:

FIGS. 1A, 1B, and 1C show schematic views, in plan view and section, of a first embodiment of the invention, in which a conductor arranged in a textile material has been severed;

FIGS. 2A, 2B and 2C show schematic views, in plan view and section, of the embodiment shown in FIGS. 1A, 1B, and 1C, in which contact-making devices provided with a contact-making means are arranged at the point of the conductor to be connected;

FIGS. 3A, 3B, and 3C show schematic views, in plan view and section, of the embodiment of FIGS. 1A, 1B and 1C in the electrically connected state; and

FIGS. 4A, 4B, and 4C show schematic views, in plan view and section, of a second embodiment of the invention in the electrically connected state.

### DETAILED DESCRIPTION OF THE PREFERRED MODE OF THE INVENTION

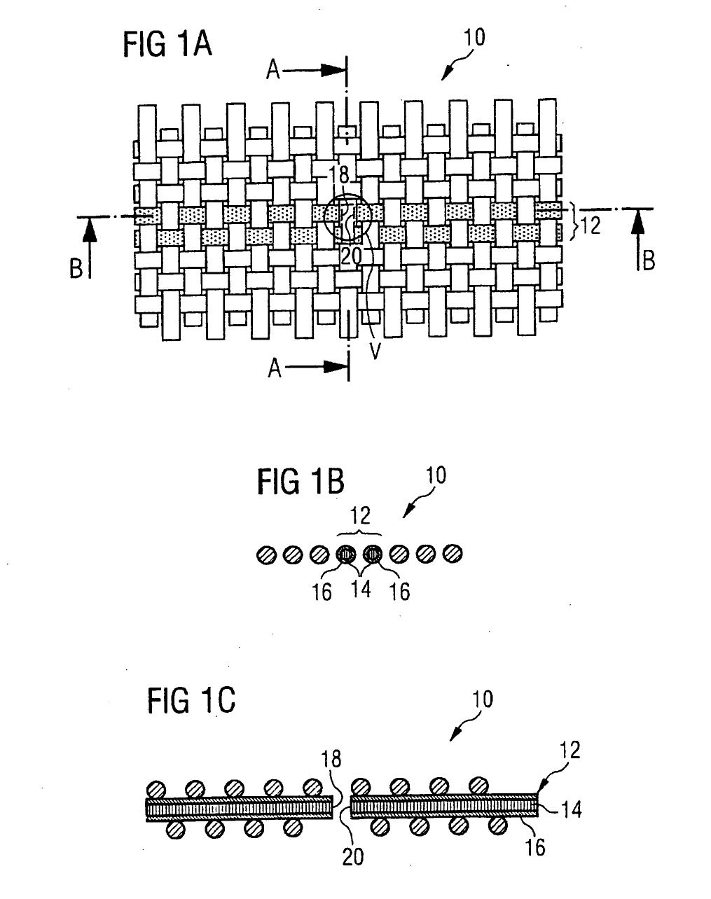

A first embodiment of an apparatus according to the invention is illustrated schematically in FIGS. 1A, 1B, and 1C.

Designation 10 designates a textile material, which is a fabric. In this case, fabric is understood to mean a two-dimensional textile structure made of two thread systems, in particular crossing at right angles, which, as usual, are designated warp and weft.

Woven into the textile material 10 is an electric conductor 12. In the embodiment illustrated, the conductor 12 comprises two electrically conductive wires or yarns or fibers 14 running substantially parallel to each other, which are surrounded by an electrically insulating sheath or insulation 16. However, depending on the application, the conductor 12 can also have any other desired number of wires.

FIG. 1A shows a plan view of the apparatus according to the first embodiment before being connected electrically to the electronic component, not illustrated, FIG. 1B shows a section along the line A-A from FIG. 1A, and FIG. 1C shows a section along the line B-B from FIG. 1A.

In order to connect the conductor 12 electrically to an electronic component, not illustrated, first of all the conductor 12 is severed at the point V to be connected. This is illustrated in FIGS. 1A, 1B and 1C. The conductor 12 is preferably severed by means of a mechanical cut using a conventional cutting tool, such as a knife or scissors. In this case, the wire 14 and the insulation 16 are preferably severed completely and two opposite cut ends 18, 20 of the conductor 12 are produced. In the embodiment illustrated, the conductor 12 has been severed in a middle region.

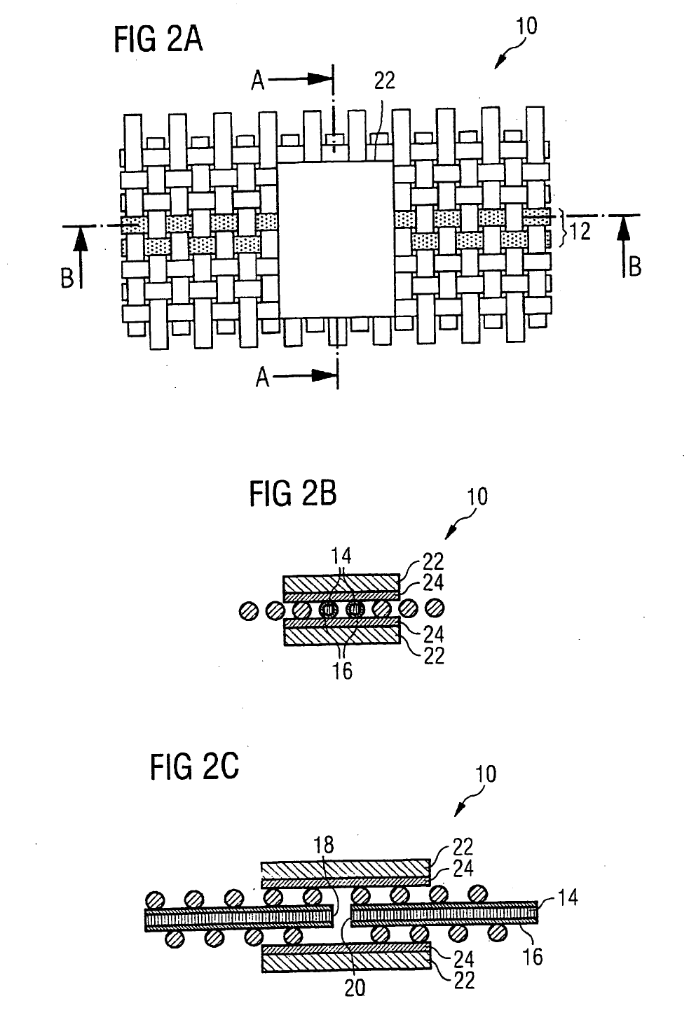

In the following text, the arrangement of a contact-making device of the component on the textile material at the point of the conductor 12 to be connected will be described with reference to FIGS. 2A, 2B and 2C.

In this case, FIG. 2A shows a plan view of an apparatus according to the first embodiment in the arrangement step, FIG. 2B shows a section along the line A-A from FIG. 2A, and FIG. 2C shows a section along the line B-B from FIG. 2A.

A contact-making device 22 is in each case positioned on both surface sides of the textile material 10 in such a way that the point V to be connected is covered by the contact-making device 22. The two contact-making devices 22 used are preferably substantially identical to each other or mirror images of each other. The contact-making devices 22 are preferably arranged in such a way that they are substantially opposite and the textile material 10 with the conductor 12 lies between them.

The contact-making device 22 is preferably formed as a small metal plate, which can be connected electrically to an electronic component, not illustrated. In the embodiment illustrated, the contact-making device 22 is connected to the electronic component only after the conductor 12 has been connected electrically to the contact-making device 22. Alternatively, provision can be made for the electronic component to be connected to the contact-making device 22 even before the conductor 12 is connected electrically to the contact-making device 22 or for the contact-making device 22 to form part of the electronic component.

In the embodiment illustrated, the contact-making device 22 is provided with a contact-making means 24. The contact-making means 24 is preferably a soldering means, normally preferably tin solder. Alternatively, the contact-making means 24 can also be a conductive adhesive, for example.

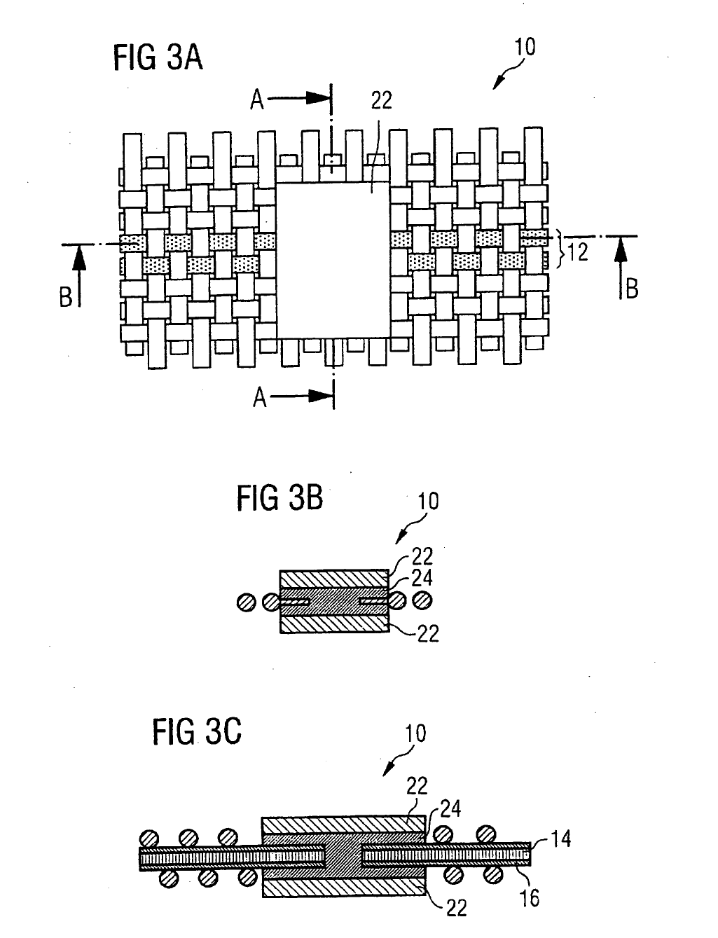

FIGS. 3A, 3B and 3C show a first embodiment of the apparatus according to the invention in an electrically connected state. In this case, FIG. 3A shows a plan view, FIG. 3B a section along the line A-A from FIG. 3A, and FIG. 3C a section along the line B-B from FIG. 3A.

The contact-making device 22 illustrated in FIGS. 2A, 2B and 2C has been supplied with warmth or heat, so that the soldering material 24 has flown into the textile material 10. In this case, the soldering means 24 has also made contact with the cut ends 18, 20 of the severed conductor 12. In particular, in this case the end faces of the severed conductor 12 are provided with the soldering means 24. As a result, an electrical connection is produced between the conductor 12 and the contact-making device 22.

As a result of providing contact-making devices 22 on both surface sides of the textile material 10, a firm and secure electrical and mechanical connection can be formed between the contact-making device 22 and the textile material 10 and the conductor 12.

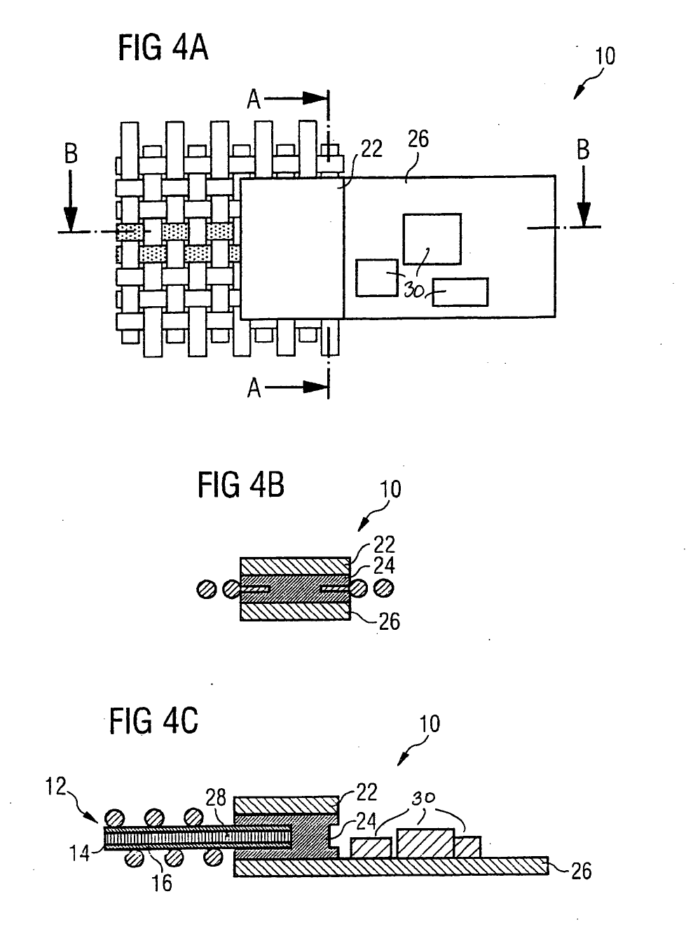

FIGS. 4A, 4B and 4C show an apparatus according to a second preferred embodiment of the present invention. In this case, FIG. 4A shows a plan view, FIG. 4B a section along the line A-A from FIG. 4A, and FIG. 4C a section along the line B-B from FIG. 4A.

In the embodiment shown in FIGS. 4A, 4B and 4C, the conductor 12 has been connected electrically to the contact-making device 22 in a side or marginal or edge region of the textile material. In this case, the conductor 12 has been severed in the side region.

In the embodiment illustrated, a contact-making device 22 as described with respect to the first embodiment is provided on one surface side of the textile material 10 (the upper side in FIG. 4C). On the other surface side of the textile material 10 (the lower side in FIG. 4C), the contact-making device is formed as a preferably integral constituent part of a preferably flexible printed circuit board 26. Electronic components 30 are provided on at least one side of the printed circuit board 26.

The electrical connection procedure is carried out in a similar manner to that in the first embodiment, but in this embodiment, the conductor 12 to be connected is severed and only one cut end 28 of the conductor 12, in this case the lateral cut end, has to be connected electrically to the contact-making device.

1. A method for electrically connecting an electric conductor to an electronic component comprising the steps of:
providing a textile material, in which at least, one flexible, wire-like and/or thread-like electric conductor is arranged;
severing the electric conductor at a point to be connected;
arranging a contact-making device of the component on at least one surface side of the textile material at the point on the conductor to be connected; and
connecting the conductor electrically to the contact-making device.

2. The method as claimed in claim 1, further comprising the step of applying a contact-maker to the contact-making device and/or the severed point of the conductor.

3. The method as claimed in claim 2, wherein the contact-maker is a soldering device.

4. The method as claimed in claim 3, wherein the electrical connection step comprises a step of heating the soldering device.

5. The method as claimed in claim 2, wherein the contact-maker is a conductive adhesive.

6. The method as claimed in claim 1, wherein the electrical connection step comprises a step of welding the conductor to the contact-snaking device.

7. The method as claimed in claim 1, further comprising a step of connecting the contact-making device electrically to the electronic component.

8. The method as claimed in claim 1, wherein the contact-making device is formed as part of the electronic component.

9. The method as claimed in claim 1, further comprising a step of arranging a contact-making device on both surface sides of the textile material.

10. The method as claimed in claim 1, wherein the conductor comprises at least one electrically conductive wire, which is sheathed with an insulation, and the step of severing the electric conductor comprises a step of severing the insulation and the wire.

11. An apparatus comprising:
a textile material, in which at least one flexible, wire-like and/or thread-like electric conductor is arranged; and
at least one contact-making device of an electronic component, which is connected electrically to the conductor;
wherein the conductor is severed at the connecting point to the contact-making device.

12. The apparatus as claimed in claim 11, wherein the contact making device and the conductor are connected electrically via a contact-maker.

13. The apparatus as claimed in claim 12, wherein the contact-maker is a soldering device.

14. The apparatus as claimed in claim 13, wherein the contact-maker is a conductive adhesive.

15. The apparatus as claimed in claim 11, wherein the contact-making device and the conductor are welded to each other.

16. The apparatus as claimed in claim 11, wherein the contact-making device is part of the component.

17. The apparatus as claimed in claim 11, wherein the contact-making device is a small metal plate.

18. The apparatus as claimed claim 11, wherein the electronic component is a flexible lead.

19. The apparatus as claimed in claim 11, wherein the textile material is a fabric and the conductor comprises at least one weft and/or warp thread of the fabric.

20. The apparatus as claimed in claim 11, wherein the conductor comprises at least one electrically conductive wire, which is sheathed with an insulation.
